(19) United States
(12) Patent Application Publication
(10) Pub. No.: US 2006/0287615 A1
(43) Pub. Date: Dec. 21, 2006

(54) MASSAGING MASK

(76) Inventor: Tsung-I Yu, Pan-Chiao City, Taipei County (TW)

Correspondence Address: PAI PATENT & TRADEMARK LAW FIRM, 1001 FOURTH AVENUE, SUITE 3200, SEATTLE, WA, 98154, US

(21) Appl. No.: 11/160,254

(22) Filed: Jun. 15, 2005

(51) Int. Cl. A61H 1/00

(52) U.S. Cl. 601/15; 601/21; 601/DIG. 3; 601/DIG. 15

(57) ABSTRACT

A massaging mask is disclosed to include an electrically insulative film, which has embedded therein conducting sockets for the connection of the positive-pole lead wire and negative-pole lead wire of a controller, and a plurality of conducting films bonded to one side of the electrically insulative film and respectively connected to the positive pole and negative pole of the controller through the conducting sockets for outputting a voltage to stimulate the circulation of blood in the user's face subject to the control of the controller.

### BACKGROUND OF THE INVENTION

(a) Field of the Invention

The present invention relates to massaging implements and more specifically, to a massaging mask for massaging the face with a medium or low frequency to stimulate the circulation of blood in the face.

(b) Description of the Prior Art

Conventional face or eye massaging masks commonly comprise a mask body, which has protruding massaging elements protruding over the inside wall and magnetic elements respectively bonded to the protruding massaging elements, and a vibrator adapted to vibrate the protruding massaging elements against the user's face so as to achieve the desired massaging effect. These conventional face or eye massaging devices are not very effective in stimulating the circulation of blood.

### SUMMARY OF THE INVENTION

The present invention has been accomplished under the circumstances in view. According to one aspect of the present invention, the massaging mask comprises an electrically insulative film, at least one conducting film bonded to one side of the electrically insulative film and a controller to output a voltage for massaging, wherein the electrically insulative film has at least one conducting terminal member embedded therein and extending through the top and bottom surfaces thereof for the connection of a respective lead wire from the controller; the at least one conducting film is respectively bonded to the bottom surface of the electrically insulative film and respectively connected to the at least one conducting terminal member for outputting a voltage to the user's face subject to the control of the controller.

According to another aspect of the present invention, the massaging mask includes multiple conducting sockets (or plugs) respectively embedded in the electrically insulative film and respectively connected to the positive pole and negative pole of the controller, and multiple conducting films respectively bonded to the electrically insulative film and separated from one another by gaps and respectively connected to the conducting sockets (or plugs).

According to still another aspect of the present invention, each conducting film has a plurality of protruding conducting members and protruding insulative members arranged over one side thereof opposite to the electrically insulative film.

According to still another aspect of the present invention, the at least one conducting film is a single piece conducting film connectable to one of the positive and negative poles of the controller, for enabling the other of the positive and negative poles of the controller to be electrically connected to a peripheral device attachable to a part of the user's body, which peripheral device can be, for example, a conducting glove.

### BRIEF DESCRIPTION OF THE DRAWINGS

FIG. 1 is a perspective view of a massaging mask according to the present invention.

FIG. 2 is an exploded view of the massaging mask according to the present invention.

FIG. 3 is a sectional view in an enlarged scale of a part of the massaging mask according to the present invention.

FIG. 4 is a schematic drawing showing an application example of the massaging mask according to the present invention.

FIG. 5 is a front view of the massaging mask according to the present invention.

FIG. 6 is a front view of an alternate form of the massaging mask according to the present invention.

FIG. 7 is a schematic exploded view showing the use of the massaging mask of the present invention with a commercially available face membrane.

FIG. 8 illustrates still another alternate form of the massaging mask according to the present invention.

FIG. 9 illustrates still another alternate form of the massaging mask according to the present invention.

FIG. 10 illustrates still another alternate form of the present invention, showing the massaging mask made in the form of an eyepiece.

FIG. 11 illustrates still another alternate form of the present invention, showing the massaging mask made in the form of a mouthpiece.

FIG. 12 illustrates still another alternate form of the massaging mask according to the present invention.

FIG. 13 is a sectional view of a part of FIG. 12.

FIG. 14 is a schematic drawing showing the massaging mask used with a conducting glove according to the present invention.

FIG. 15 shows the connectivity of the central integrated circuit of the controller of the present invention.

FIG. 16 is the circuit layout of the controller of the present invention.

### DETAILED DESCRIPTION OF THE PREFERRED EMBODIMENTS

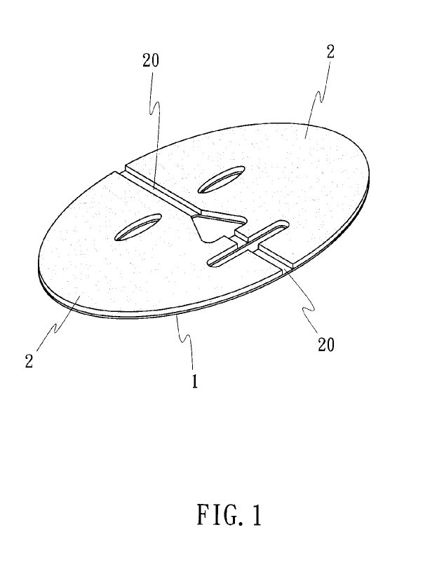

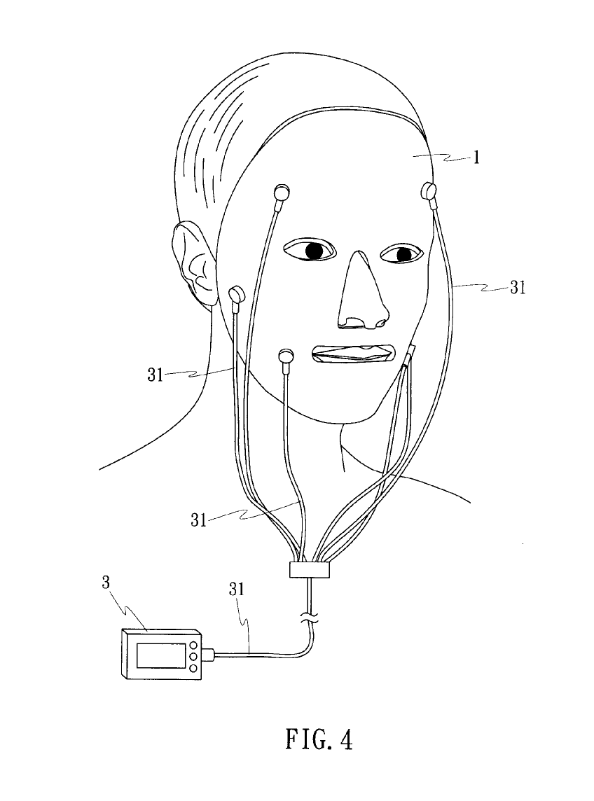

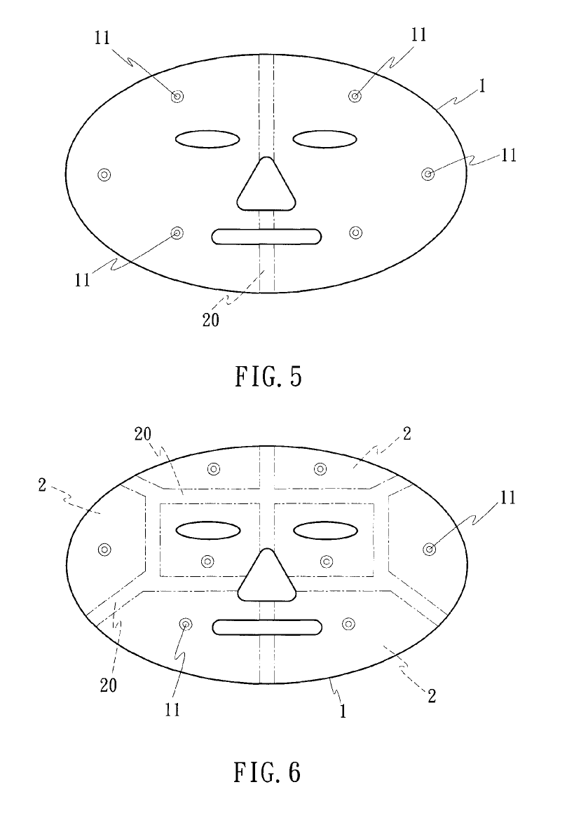

Referring to FIGS. 1-5, a massaging mask in accordance with the present invention is shown comprising an electrically insulative film 1, at least one, for example, two conducting films 2 bonded to the electrically insulative film 1, and a controller 3 electrically connectable to the conducting films 2 to provide a medium or low frequency to the conducting films 2 for massaging the user's face and stimulating the circulation of blood in the user's face.

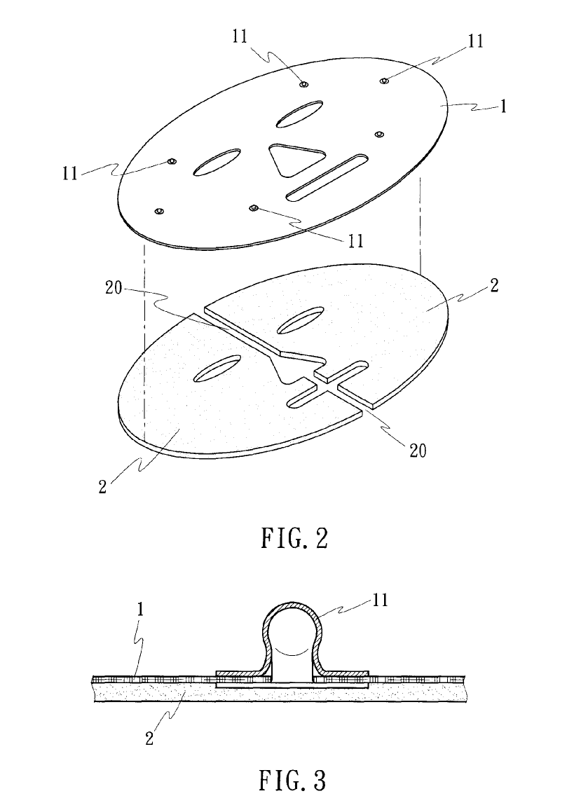

The electrically insulative film 1 has a plurality of conducting plugs 11 embedded therein and spaced from one another and extending through the top and bottom surfaces thereof. The conducting films 2 are covered on the bottom surface of the electrically insulative film 1 and kept electrically connected to the conducting plugs 11 (see FIGS. 2 and 3). Further, after bonding of the conducting films 2 to the bottom surface of the electrically insulative film 1, a gap 20 is kept between the two conducting films 2.

When in use, the positive-pole or negative-pole lead wires 31 of the controller 3 are connected to the conducting plugs 11, and then the controller 3 is operated to output a medium or low frequency to the conducting films 2 to stimulate the circulation of blood in the user's face, achieving the desired massaging effect.

FIG. 6 shows an alternate form of the present invention. According to this embodiment, the bottom surface of the electrically insulative film 1 is divided into multiple conducting zones, and multiple conducting films 2 are respectively bonded to the conducting zones of the bottom surface of the electrically insulative film 1 and spaced from one another by gaps 20. Further, each conducting zone of the electrically insulative film 1 has one conducting plug 11 embedded therein and kept in contact with the respective conducting film 2. When in use, the controller 3 can be operated to selectively output a medium or low frequency to the conducting plugs 11 to massage the assigned area of the user's face, or to massage the user's face from one area to another in a proper order.

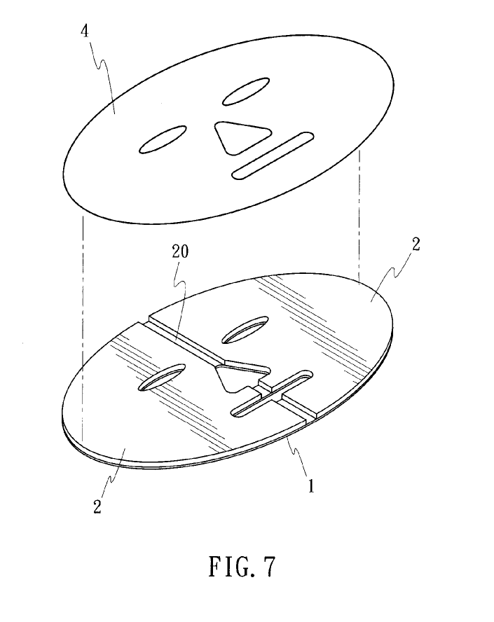

When the present invention is in use, the conducting films 2 may be covered with a layer of conducting glue or dry adhesive so that the massaging mask can positively be adhered to the user's face. Alternatively, the massaging mask can be used with a commercially available face membrane 4 (see FIG. 7). In this case, the conducting films 2 are preferably formed of a conducting rubber or fabric, and the face membrane 4 is covered on the conducting films 2 of the massaging mask and bonded with the massaging mask to the user's face. When started, a low frequency power is transmitted to the user's face through the conducting films 2 and the face membrane 4 to stimulate the circulation of blood in the user's face.

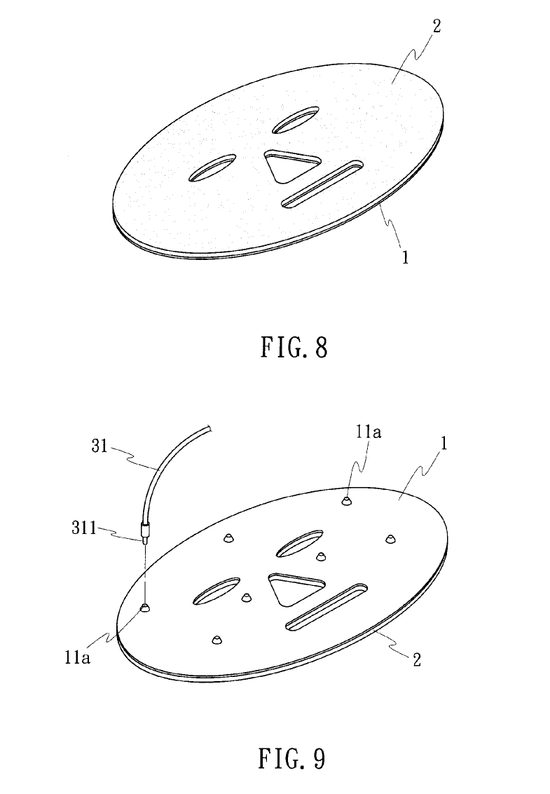

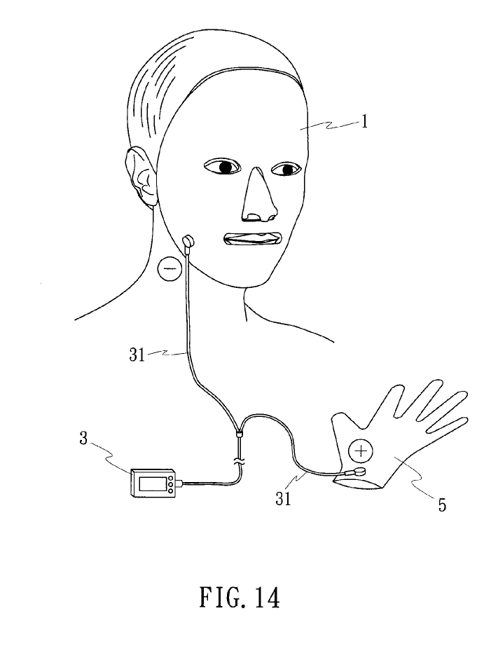

FIG. 8 shows another alternate form of the present invention. According to this embodiment, the massaging mask is comprised of one electrically insulative film 1 and one conducting film 2. The massaging mask can be used with a conducting glove 5 for massaging the user's face and hands (see FIG. 14).

FIG. 9 shows still another alternate form of the present invention. According to this embodiment, conducting sockets 11a are embedded into the electrically insulative film 1 and kept in contact with the conducting film(s) 2 for receiving the connecting pins 311 of the respective lead wires 31 of the controller 3.

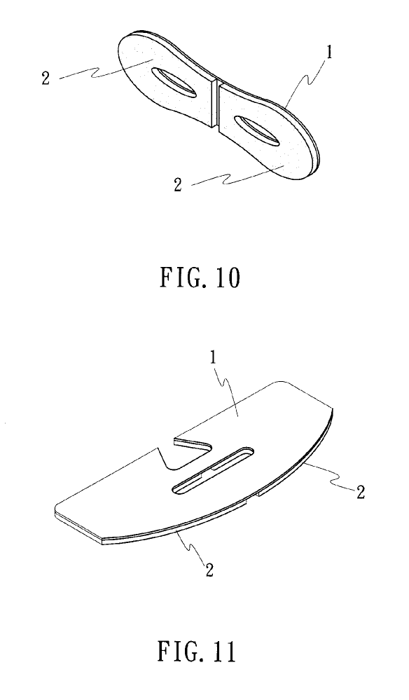

Further, the massaging mask of the present invention can be made in any of a variety of shapes to cover the whole or a part of the face of a person. For example, the massaging mask can be made in the form of a facemask to cover the whole area of the user's face (see FIGS. 1˜9), in the form of an eyepiece to cover the area around the eyes (see FIG. 10), or in the form of a mouthpiece to cover the area around the mouth (see FIG. 11). Further, the massaging mask has a curvature fitting the face of a person and holes corresponding to the eyes, nose, and/or mouth of a person.

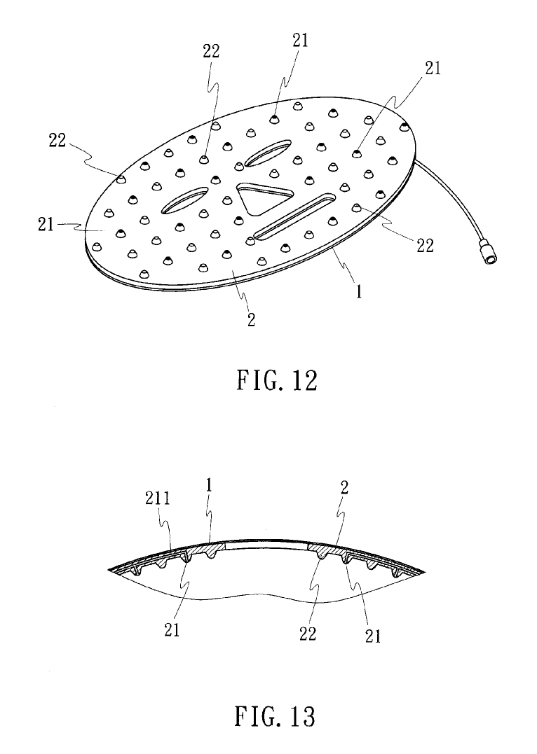

FIG. 12 shows still another alternate form of the present invention. According to this embodiment, the conducting film 2 has a plurality of protruding conducting members 21 and protruding insulative members 22 arranged over one side thereof opposite to the electrically insulative film 1. The protruding insulative members 22 are respectively spaced around each of the protruding conducting members 21 and adapted to enhancing the massaging effect on a respective local area. The protruding conducting members 21 can be formed integral with a conducting material 211 that is embedded in the conducting film 2 (see FIG. 13) and connected to the conducting plugs 11 or conducting sockets 11a of the insulative film 1 (see also FIGS. 2 and 9).

Referring to FIG. 14, the controller 3 has positive-pole and negative-pole lead wires 31 respectively connected to the conducting plug or socket at the insulative film 1 and the conducting glove 5. When in use, the massaging mask is attached to the user's face, and the conducting glove 5 is attached to one hand of the user, and then the controller 3 is operated to output a medium or low frequency to the user's face and hand to stimulate the circulation of blood in the user's face and hand, achieving the desired massaging effect.

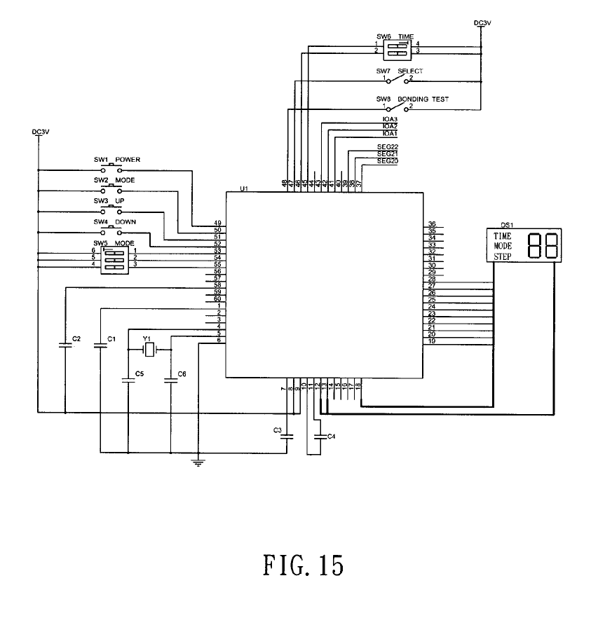

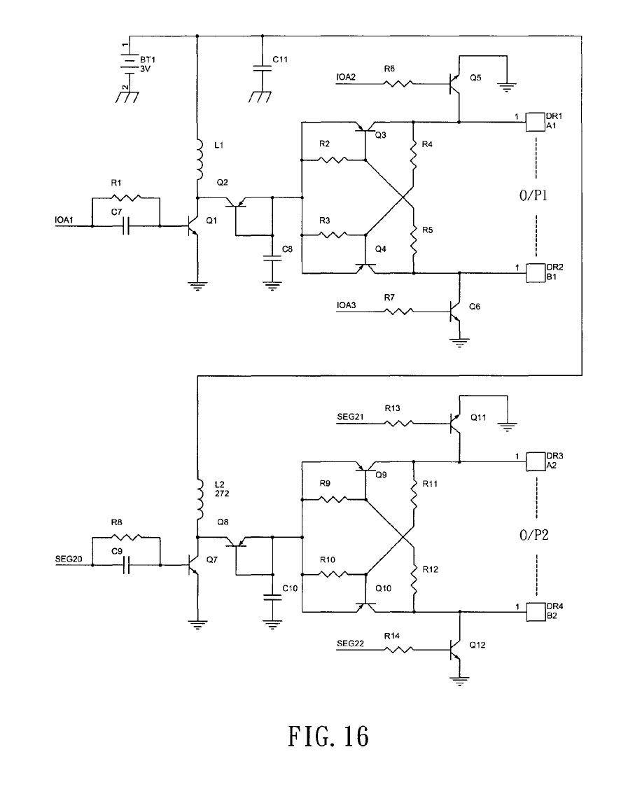

Referring to FIGS. 15˜16, the controller 3 has a main IC to provide a pulse waveform, causing inductor and capacitor means to charge and discharge and to further produce a high voltage. The pulse width is controlled by a program to be within about 1 Hz˜150 Hz. Therefore, the controller 3 can provide a pulse voltage by means of its internal circuit.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A massaging mask comprising
an electrically insulative film,
at least one conducting film bonded to one side of said electrically insulative film, and
a controller which can output a voltage for massaging,
wherein said electrically insulative film has at least one conducting terminal member embedded therein and extending through the top and bottom surfaces thereof for connection of a respective lead wire from said controller; and
said at least one conducting film is respectively bonded to the bottom surface of said electrically insulative film and respectively connected to said at least one conducting terminal member for outputting a voltage to the user's face subject to the control of said controller.

2. The massaging mask as claimed in claim 1, wherein said at least one conducting film is formed of a conducting rubber or a conducting fabric, and has one side covered with a face membrane opposite to said electrically insulative film.

3. The massaging mask as claimed in claim 1, wherein said at least one conducting film is a single piece conducting film connectable to one of the positive and negative poles of said controller, and the other of the positive and negative poles of said controller is electrically connected to a peripheral device attachable to a part of the user's body.

4. The massaging mask as claimed in claim 3, wherein said peripheral device is a conducting glove.

5. The massaging mask as claimed in claim 1, wherein said at least one conducting terminal member each is a conducting socket.

6. The massaging mask as claimed in claim 1, wherein said at least one conducting film each has a plurality of protruding conducting members and a plurality of protruding insulative members arranged over one side thereof opposite to said electrically insulative film.

7. The massaging mask as claimed in claim 6, wherein said protruding conducting members are respectively formed integral with a respective conducting material respectively embedded in said at least one conducting film for connection of one of the positive pole and negative pole of said controller respectively.

8. The massaging mask as claimed in claim 6, wherein said protruding conducting members are respectively formed integral with a respective conducting material respectively embedded in said at least one conducting film and respectively connected to the at least one conducting terminal member of said electrically insulative film.
